(19) United States
(12) Patent Application Publication
(10) Pub. No.: US 2018/0136358 A1
(43) Pub. Date: May 17, 2018

(54) Systems, Methods, Apparatuses, and Software for Measuring Electrical Properties of a Material

(71) Applicant: Transcend Engineering and Technology, LLC, Bethel, VT (US)

(72) Inventor: Stephen P. Farrington, Stockbridge, VT (US)

(21) Appl. No.: 14/813,793

(22) Filed: Jul. 30, 2015

Related U.S. Application Data
(60) Provisional application No. 62/030,977, filed on Jul. 30, 2014.

(51) Int. Cl. G01V 3/30; G01V 13/00

(52) U.S. Cl. CPC G01V 3/30; G01V 13/00

(57) ABSTRACT

Various methods of measuring electrical parameters of a material that may relate to other properties or states of the material are disclosed herein. Such a measurement can be made by, e.g., deploying a parallel conductive waveguide into a cavity formed in the material and observing changes in the electrical characteristics of the waveguide attributable to the properties of material proximal to which the waveguide is disposed. In one embodiment the material under test is soil or rock and the cavity is a borehole formed via drilling or direct push technology. Dielectric permittivity is an electrical parameter indicative of the water content of the soil or rock; measurements thereof may utilize an electrically conductive waveguide along which an electromagnetic wave or pulse is conducted. Electrical properties can be inferred from the effect they have on such an incident signal due to the proximity of the waveguide to the material under test.

### RELATED APPLICATION DATA

This application claims the benefit of priority of U.S. Provisional Patent Application Ser. No. 62/030,977, filed on Jul. 30, 2014, and titled “Systems, Methods, and Apparatuses for Measuring Electrical Properties of a Material,” which is incorporated by reference herein in its entirety.

### STATEMENT REGARDING FEDERALLY SPONSORED RESEARCH OR DEVELOPMENT

This invention was made with U.S. government support under SBIR Grant DE-SC0009646 awarded by the Department of Energy. The government has certain rights in this invention.

### FIELD OF THE INVENTION

The present invention generally relates to the field of measuring and testing. In particular, the present invention is directed to systems, methods, apparatuses, and software for measuring electrical properties of a material.

### BACKGROUND

Various attempts to produce meaningful analytics of electrical properties of materials have resulted in development of systems and methods that are usable in particular instances for particular purposes but that are not suitable or optimized for, e.g., ascertaining a spatial profile of electrical or dielectric properties of the materials. Due to various shortcomings of the prior art, new technologies need to be developed to increase the quality of analytical methodologies available to geologists, security professionals, and government officials, among others.

### SUMMARY OF THE DISCLOSURE

Methods of measuring electrical parameters of a material that may relate to other properties or states of the material are disclosed herein. In some embodiments, such a measurement can be made by deploying a parallel conductive waveguide (which may also be referred to as a transmission line or a probe) into a cavity formed in the material and observing changes in the electrical characteristics of the waveguide attributable to the properties of material proximal to which the waveguide is disposed. In one embodiment, the material under test is soil or rock and the cavity is a borehole formed via drilling or direct push technology. Dielectric permittivity is an electrical parameter indicative of the water content of the soil or rock; measurement thereof may utilize an electrically conductive waveguide along which an electromagnetic wave or pulse is conducted. Electrical properties can be inferred from the effect they have on such an incident signal due to the proximity of the waveguide to the material under test.

In one implementation, a method of determining one or more parameters associated with materials adjacent a cavity having at least one sidewall and proximate and distal portions is provided, the method being at least partially implemented with measurement instrumentation. Such a method may include: disposing at least a portion of a flexible, substantially impermeable liner within the cavity such that it is proximal to the at least one sidewall; disposing one or more waveguides, comprising one or more electrical conductors, proximal to the liner such that the one or more waveguides are proximal to and substantially electrically insulated from the at least one sidewall; and monitoring electrical characteristics of the one or more waveguides via the measurement instrumentation to determine one or more parameters associated with the materials at the at least one sidewall.

In another implementation, a method of installing a system usable for determining one or more parameters associated with materials adjacent a cavity having at least one sidewall and proximate and distal portions is provided. Such a method may include: disposing at least a portion of a flexible, continuously impermeable liner within the cavity such that it is proximal to the at least one sidewall; and disposing one or more waveguides, comprising one or more electrical conductors, proximal to the liner such that the one or more waveguides are proximal to and substantially electrically insulated from materials adjacent the cavity.

In still another implementation, a system for determining one or more parameters associated with materials adjacent a cavity having at least one sidewall and proximate and distal portions is provided. Such a system may include: a flexible, substantially impermeable liner designed and configured to be disposed at least partially within the cavity such that it is proximal to the at least one sidewall; and one or more waveguides, comprising one or more electrical conductors, designed and configured to be deployed in conjunction with the liner such that the one or more waveguides are proximal to the liner and proximal to and substantially electrically insulated from the at least one sidewall.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a flow diagram illustrating a method of determining one or more parameters associated with materials adjacent a cavity having at least one sidewall and proximate and distal portions;

FIG. 2 is a flow diagram illustrating a method of installing a system usable for determining one or more parameters associated with materials adjacent a cavity having at least one sidewall and proximate and distal portions;

FIG. 3 is a transverse cross-sectional view showing a parallel 2-conductor waveguide disposed in a pocket on the interior surface of a liner;

FIG. 4 is a transverse cross-sectional view showing a parallel 2-conductor waveguide disposed in a pocket on the exterior surface of a liner;

FIG. 5 is a transverse cross-sectional view showing a parallel 3-conductor waveguide affixed to the exterior surface of a liner using an adhesive;

FIG. 6 is a transverse cross-sectional view showing an embodiment in which parallel waveguide conductors are embedded in liner material that electrically insulates the conductors;

FIG. 7 is a side cross-sectional view showing a liner being lowered into a borehole with a waveguide disposed in a pocket on the interior surface of the liner during emplacement in a borehole with temporary casing;

FIG. 8 is a side cross-sectional view showing a waveguide disposed in a pocket on the interior surface of a liner during emplacement in a borehole with temporary casing while flowable material fills the liner concurrent with the temporary casing being withdrawn;

FIG. 9 is a side cross-sectional view showing a waveguide disposed in a pocket on the interior surface of a liner installed in a borehole;

FIG. 10 is a perspective view showing a plurality of waveguides disposed on the exterior surface of a liner installed in a borehole; and

FIG. 11 is a block diagram of a computing system that can be used to implement any one or more of the methodologies disclosed herein and any one or more portions thereof.

### DETAILED DESCRIPTION

Aspects of the present disclosure include systems, methods, apparatuses, and software for measuring electrical properties of one or more materials. In some embodiments, an insulated, flexible waveguide disposed in or proximal to a material can be used to analyze electrical properties of the material(s) by applying controlled electrical excitations to the waveguide and monitoring reflections or other consequences of such excitations. By utilizing aspects of the present disclosure, a spatial profile of electrical or dielectric properties of materials can be produced as a function of reflections or other consequences of such excitations.

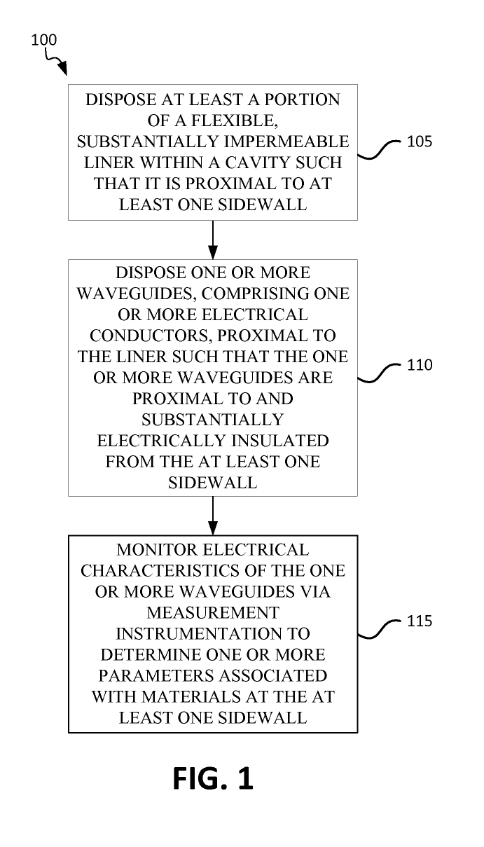

Referring now to the drawings, FIG. 1 illustrates an exemplary method 100 of determining one or more parameters associated with materials adjacent a cavity having at least one sidewall and proximate and distal portions. Such a method may be implemented at least partially with appropriate measurement instrumentation, as described further herein. As shown, method 100 may include various steps and may begin with a step 105 of disposing at least a portion of a flexible, substantially impermeable liner within the cavity such that it is proximal to the at least one sidewall. Step 110 may include disposing one or more waveguides, comprising one or more electrical conductors, proximal to the liner such that the one or more waveguides are proximal to and substantially electrically insulated from the at least one sidewall. Although step 110 follows step 105 in the flow diagram of method 100, it is emphasized that steps 105 and 110 may be performed in the opposite order, i.e., step 110 may be performed before step 105 in some implementations. Step 115 may include monitoring electrical characteristics of the one or more waveguides via the measurement instrumentation to determine one or more parameters associated with the materials at the at least one sidewall. In some embodiments, step 115 may additionally include monitoring electrical characteristics of the one or more waveguides using time domain reflectometry. By using a method like method 100, a spatial profile of electrical or dielectric properties of the materials can be ascertained, which can be very useful for geologists, earth scientists, engineers, growers, security professionals, and government officials, among others.

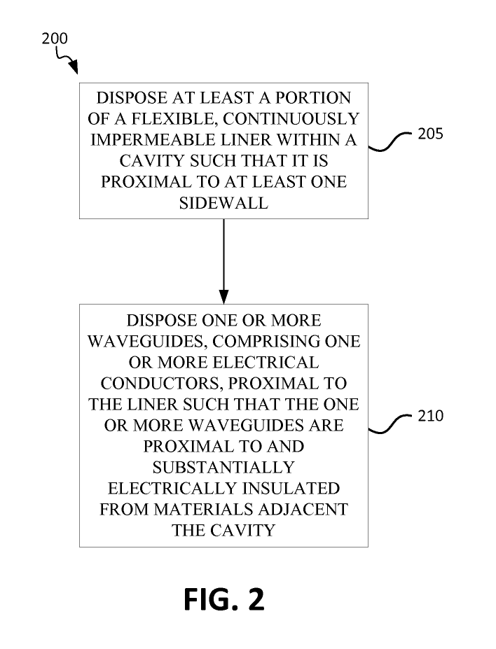

FIG. 2 illustrates an exemplary method 200 of installing a system usable for determining one or more parameters associated with materials adjacent a cavity having at least one sidewall and proximate and distal portions. As shown, method 200 may include a step 205 of disposing at least a portion of a flexible, continuously impermeable liner within the cavity such that it is proximal to the at least one sidewall and a step 210 of disposing one or more waveguides, comprising one or more electrical conductors, proximal to the liner such that the one or more waveguides are proximal to and substantially electrically insulated from materials adjacent the cavity. As with method 100, although step 210 follows step 205 in the flow diagram of method 200, it is emphasized that steps 205 and 210 may be performed in the opposite order, i.e., step 110 may be performed before step 105 in some implementations. By using a method like method 200, the groundwork can be laid for ascertaining a spatial profile of electrical or dielectric properties of the materials such that a technician, drone, or other robotic device can come to the installation site at a later time, electrically connect appropriate measurement instrumentation to the waveguide(s), either directly or indirectly using either physical wiring or wireless technology, and monitor electrical characteristics of the waveguide(s) to collect data that can be used to produce such a spatial profile. In some embodiments, a radio transceiver, antenna, and/or other communication device or interface can be attached to the waveguide, in some embodiments along with appropriate measurement instrumentation, such that regular, timed, scheduled, and/or irregular measurements and/or profiles can be produced and/or reported automatically, automatedly, and/or autonomously. In such implementations, it may be ideal to bury any measurement instrumentations or other electronics such that only an antenna or other communication device, along with any necessary electrical connections, is exposed to the elements and thus potentially to vandalism or other damages. However, measurement instrumentation or other electronics may also be housed within one or more secure and/or protected housings, which are well known in the electrical housing arts and, as such, will not be described in detail herein.

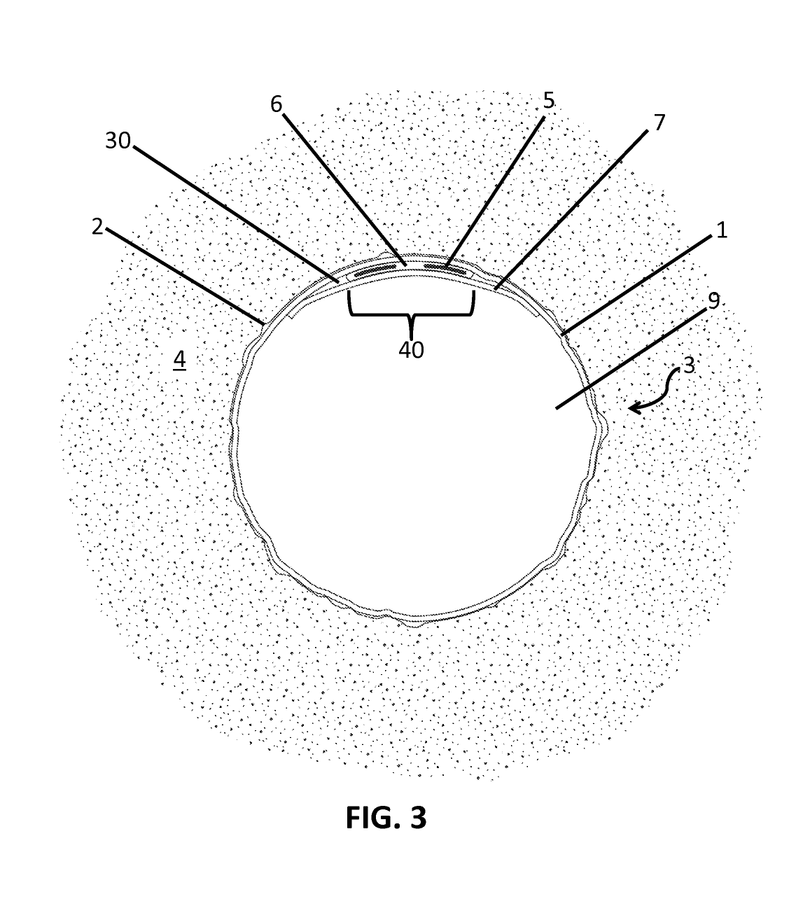

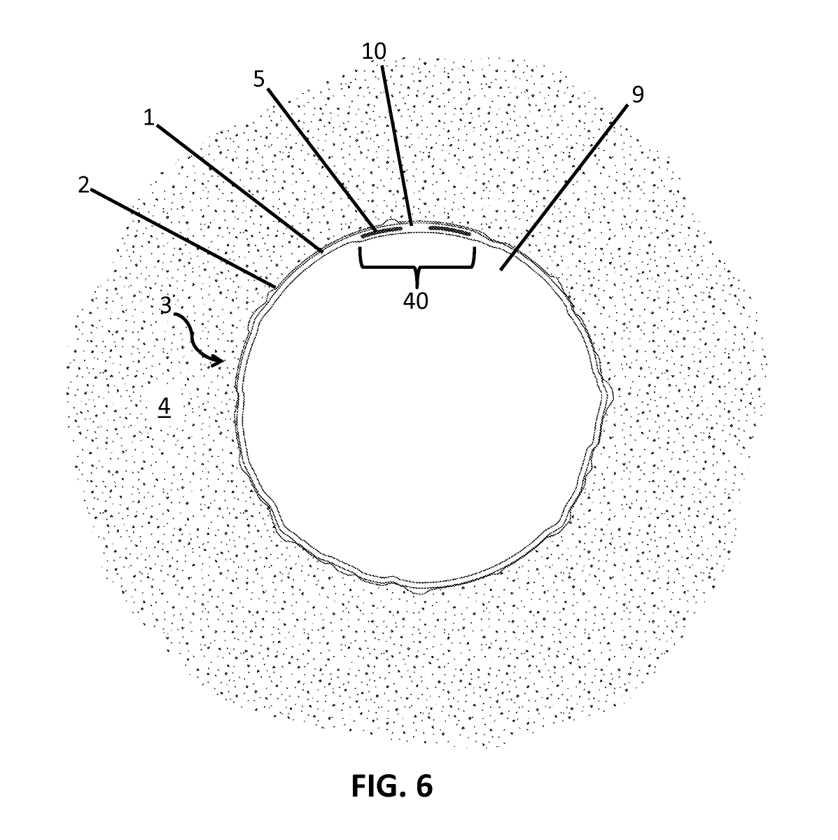

Turning now to FIG. 3, in some embodiments, apparatuses and methods of the present disclosure may use a flexible liner 1 that is inflated or otherwise brought into contact with an inside surface 2 of a cavity or borehole 3 to dispose a waveguide 40 in proximity to material under test 4. In some embodiments, waveguide 40 may be flexible so that it closely conforms to the interior shape of the borehole. One suitable implementation of the waveguide may use flat flexible cable, composed of parallel copper conductors 5 enclosed in an insulating material 6 composed of polyester, polyimide, polyurethane, or other film. In another suitable implementation, the flexible liner may comprise an electrically insulating material, such that the parallel conductors need not be fully enclosed by an insulating material that is separate from the liner, but may be embedded in the liner (see, e.g., FIG. 6) or may be adhered to the inside surface of the liner, or may be backed by or adhered to the face or one or more layers of insulating material adhered to the liner or disposed within a pocket in the liner. Other combinations of separate conductors enclosed in other insulators can be used.

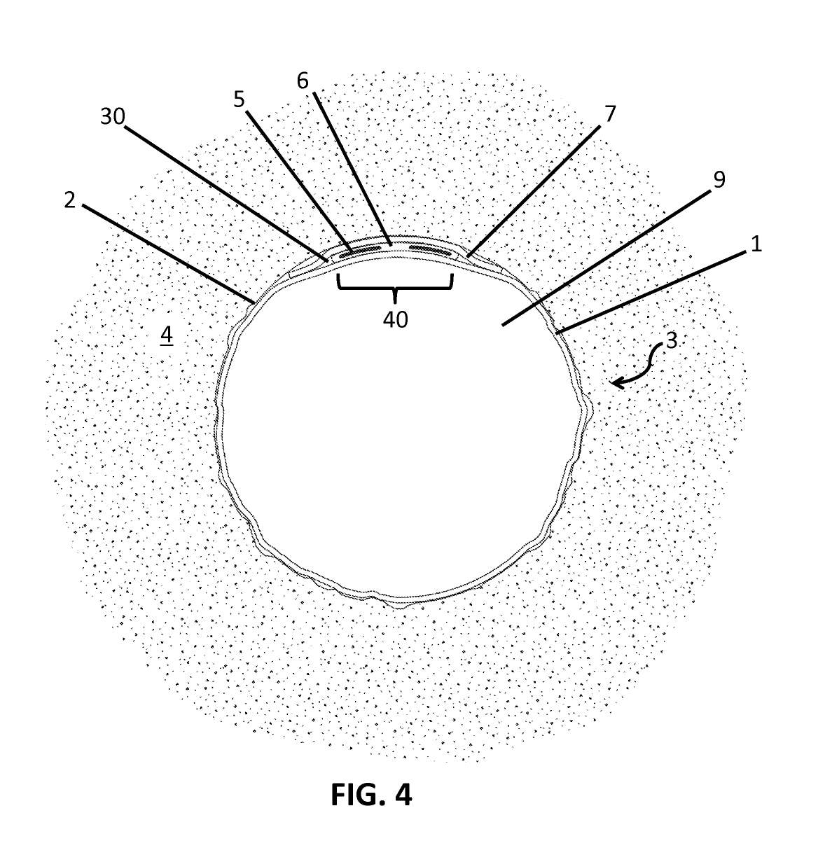

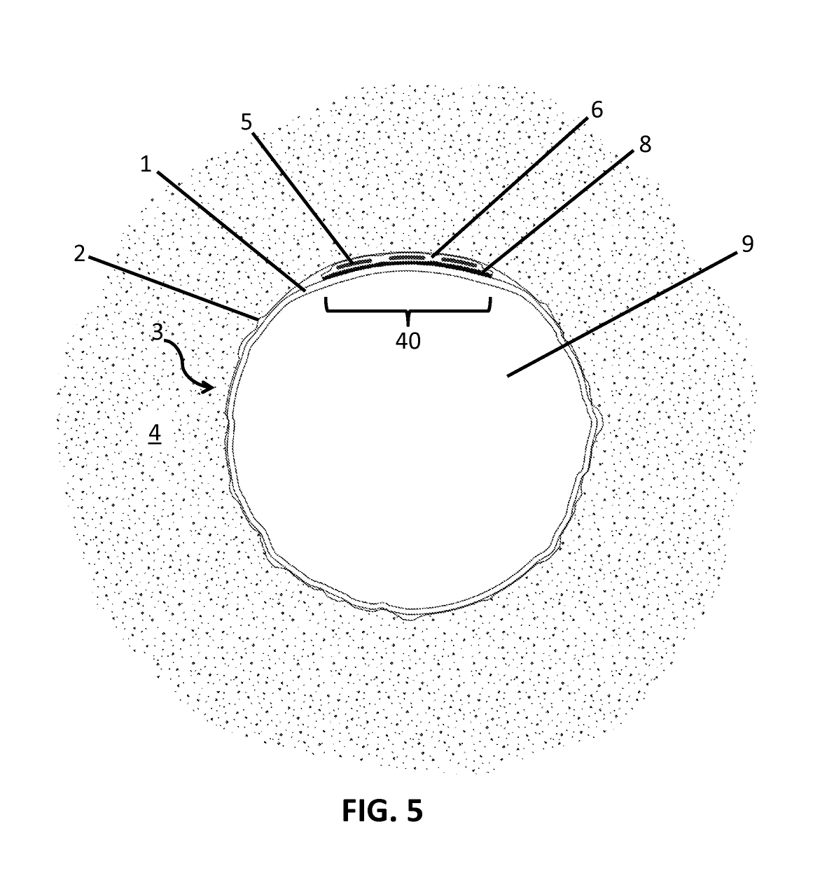

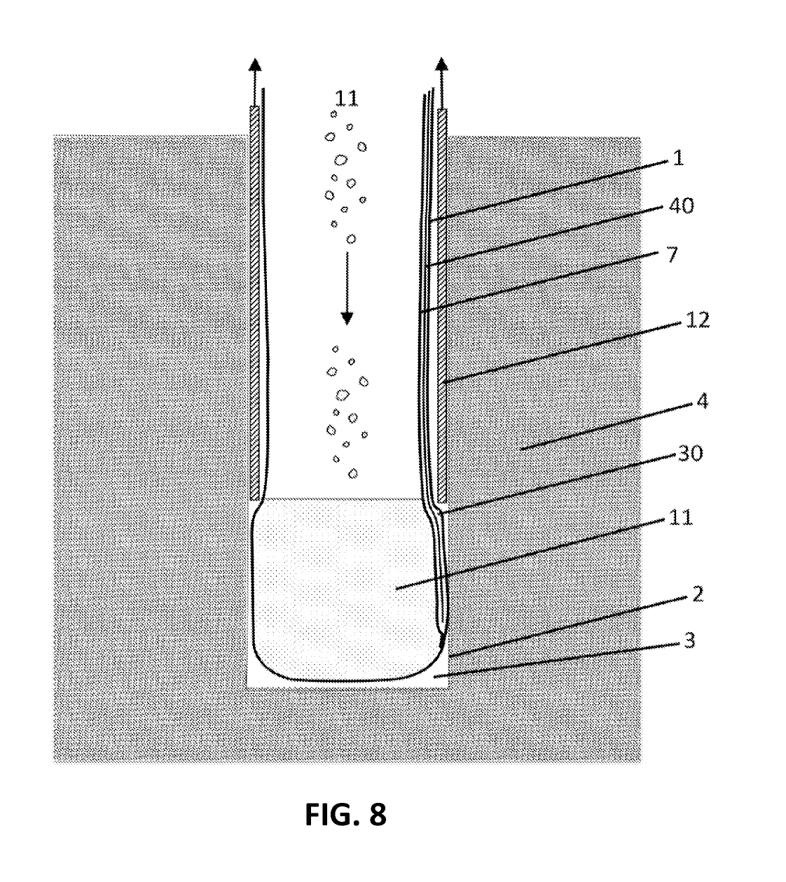

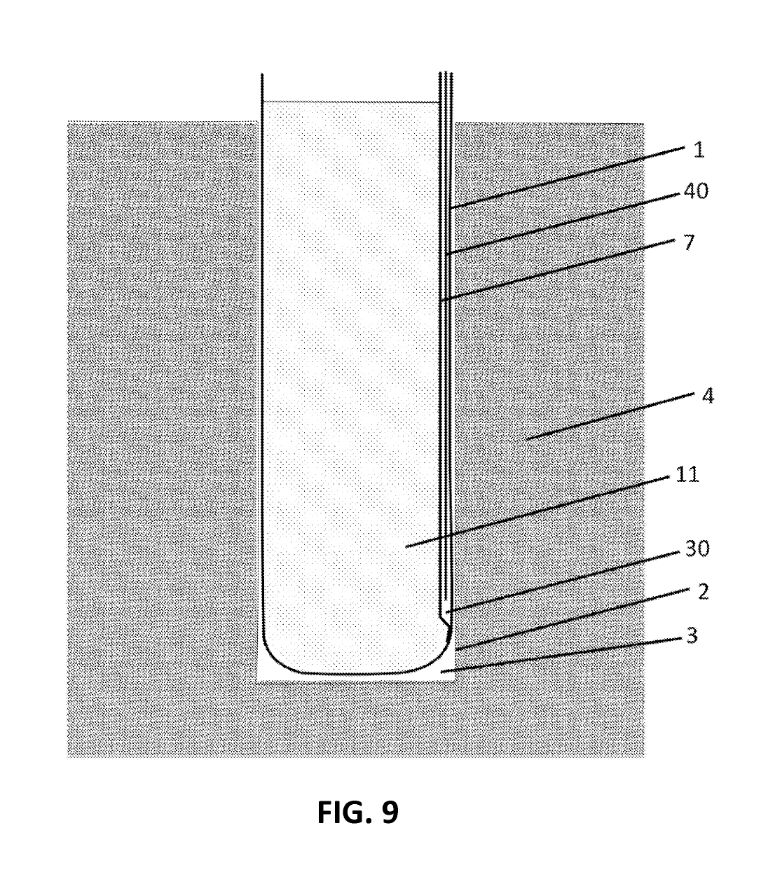

A suitable material for the borehole liner 1 is one that will prevent a liner fill material 11 (see, e.g., FIGS. 8-9) from leaking out of the liner and will also prevent moisture originating in the material under test 4 from seeping into the liner (i.e., substantially impermeable). One suitable liner material is polyurethane coated nylon. The liner may be either open or closed at the top. A liner that is closed at the top may include a means for accepting the fill material; such a means may comprise a resealable opening, a one-way or two-way valve, or other appropriate means. Providing liner 1 with a continuous “pocket” 30 formed by an additional layer of a material 7 welded or otherwise affixed to the interior (see FIG. 3) or exterior (see FIG. 4) surface of the liner is one effective means to dispose the waveguide against the material under test 4 when the liner is inflated or otherwise brought into contact with inside surface 2 of cavity 3. Parallel waveguide 40 can be attached to the interior or exterior of liner 1, such as with adhesive 8 (see FIG. 5), formed by embedding conductors 5 in the liner material 10 during manufacture (see FIG. 6), or inserted in pocket 30 on the inside or outside of liner 1 before or after the liner has been inserted into the borehole (see FIGS. 3-4). If waveguide 40 is disposed inside a liner that is closed or sealed at the top, the liner may contain a means of passing a cable to connect the waveguide to a measurement instrument, which may comprise a time domain reflectometer, oscilloscope, vector network analyzer, or other suitable measurement instrument, that is typically but not necessarily disposed outside the liner; such a means may comprise a resealable opening, a one-way or two-way valve, or other appropriate means.

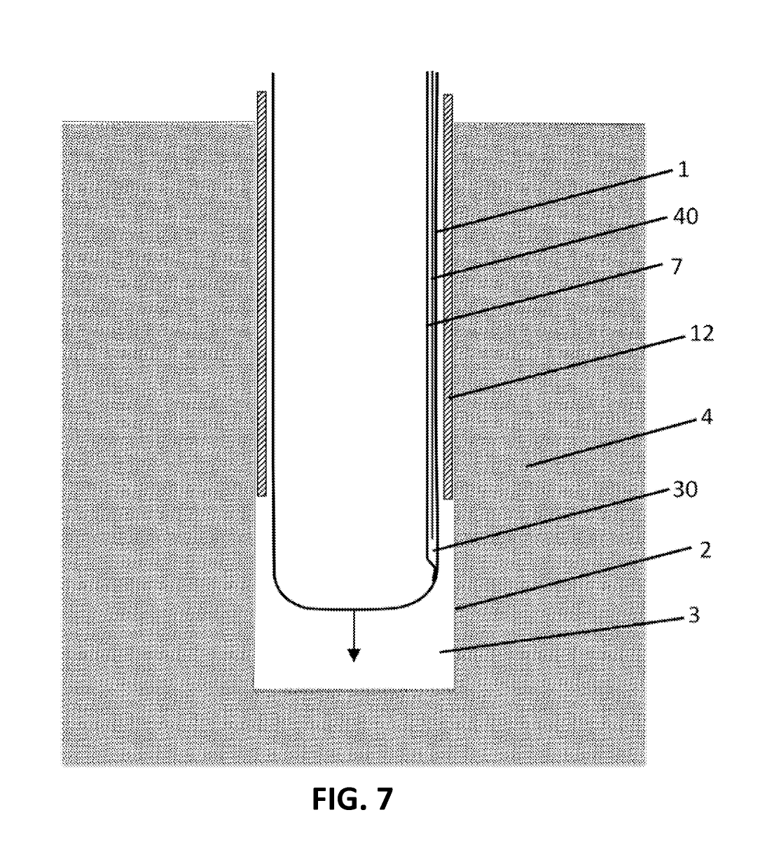

The interior 9 of borehole liner 1 can be inflated by filling with any of a variety of free-flowing materials 11 (see FIG. 7 for a liner prior to filling with materials, FIG. 8 for an example of a liner partially filled with materials 11, and FIG. 9 for an example of a liner substantially filled with materials 11). Preferred fill materials will have a low dielectric constant (i.e., below about 10, and preferably below about 6, at 68° Fahrenheit), although fill materials with higher dielectric constants can be used in less ideal implementations. Suitable fill materials include liquids, such as corn oil, pressurized gas, such as air, granular solids, such as dry sand, curable materials, such as cement-bentonite grout, flexible compressible solid-forming materials, such as expanding polyurethane foam, and/or a resin. Other materials are also suitable for filling the liner.

FIGS. 7-9 show different stages of one effective procedure for disposing waveguide 40 in proximity to soil, rock, or other material under test 4 to be tested. In the procedure shown, borehole 3 is created via rotary drilling or direct push means (not shown), optionally leaving a temporary casing 12 in place through which an un-inflated (e.g., unfilled) flexible liner 1 can be lowered into the borehole with parallel waveguide 40 attached to the liner as described above (see FIG. 7). Liner 1 is then inflated in the borehole in a manner that causes the waveguide to be disposed in close proximity to the materials that form the interior surface of the borehole such that one or more methods of analyzing the materials disclosed herein can be used effectively. FIG. 8 shows inflation of the liner by one means of filling it with flowable material 11.

If temporary borehole casing 12 is used to prevent borehole 3 from collapsing while liner 1 and waveguide 40 are installed, then the liner can be filled gradually from the bottom up by dropping in or otherwise depositing fill material 11 (as illustrated by the downward pointing arrow in FIG. 8) while the temporary casing is gradually withdrawn (as illustrated by the upward pointing arrows in FIG. 8). Liner 1 can be inflated and the casing withdrawn, either concurrently or in alternating increments, in such a manner that the rate of fill is sufficient to create enough pressure against inside surface 2 of borehole 3 to prevent the borehole from collapsing and to anchor the liner against the inside surface of the borehole but little enough pressure that the weight of fill in the liner above the bottom of the casing does not induce enough friction between the liner and temporary casing 12 to enable the casing to drag the liner with it during withdrawal from the borehole or to damage the liner as the casing is withdrawn. FIG. 9 shows the filled liner 1 and waveguide 40 disposed in borehole 3 after the temporary casing has been withdrawn. Notably, FIGS. 7-9 show only one method of disposing the parallel waveguide 40 proximal to inside surface 2 of cavity 3 using a flexible inflatable liner 1. Other methods may also be used, which will become apparent to those of ordinary skill in the art after reading this disclosure in its entirety.

Once disposed proximal to inside surface 2 of borehole 3, one or more waveguides 40 per borehole can then be monitored using time domain reflectometry (TDR) and/or one or more other measurement techniques to ascertain a spatial profile of the electrical and/or dielectric properties of the material 4 forming inside surface 2 of the borehole, from which can be inferred a moisture content profile for the material. One suitable example of measurement techniques for this purpose is disclosed in U.S. Provisional Patent Application Serial No. 62/031,064 filed on July 30, 2014, and titled “Systems and Methods for Determining Spatially Variable Distributions of the Dielectric Properties of a Material,” which is invented by the same inventor as this application, the disclosure of which is hereby incorporated by reference for its teachings of such measurement techniques. Other measurement techniques may be used.

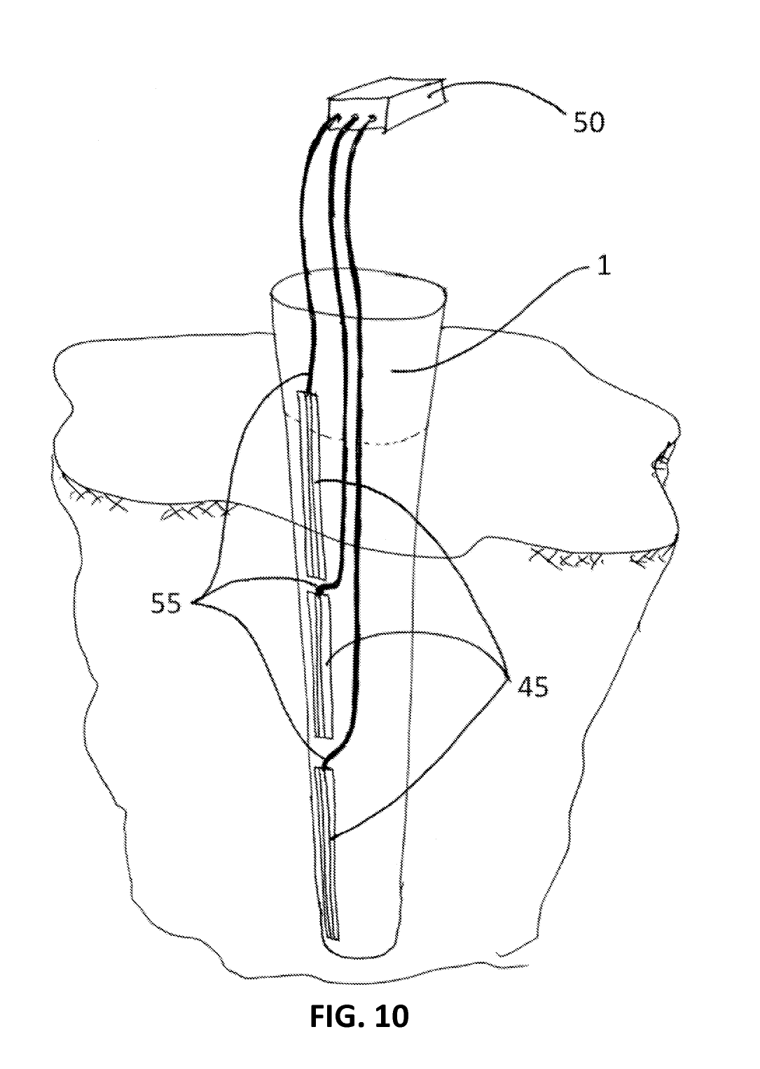

As shown in FIG. 10, multiple waveguides 45 of different lengths less than that of borehole 3 or liner 1 can be placed in the borehole at different depth intervals, each being electrically connected to measurement instrumentation 50 via separate coaxial cables 55 to the surface. Although shown in FIG. 10 as a sequential series of non-overlapping waveguides 45, such waveguides may overlap or be otherwise arranged. For example, a first waveguide may extend the entire length of a borehole, another may extend from the top, bottom, or from any other position along the first waveguide to another location, and a third may extend from any other position within the borehole or along the other waveguides to any another position. Various other implementations using more or fewer than three waveguides in any combination of lengths and degrees of overlap are possible and certain configurations can be more effective in particular situations and/or environments than others; those of ordinary skill in the art will readily be able to utilize these and other aspects of the invention without undue experimentation after reading this disclosure in its entirety.

It is to be noted that any one or more of the aspects and embodiments described herein, including methods, may be conveniently implemented partially or wholly using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

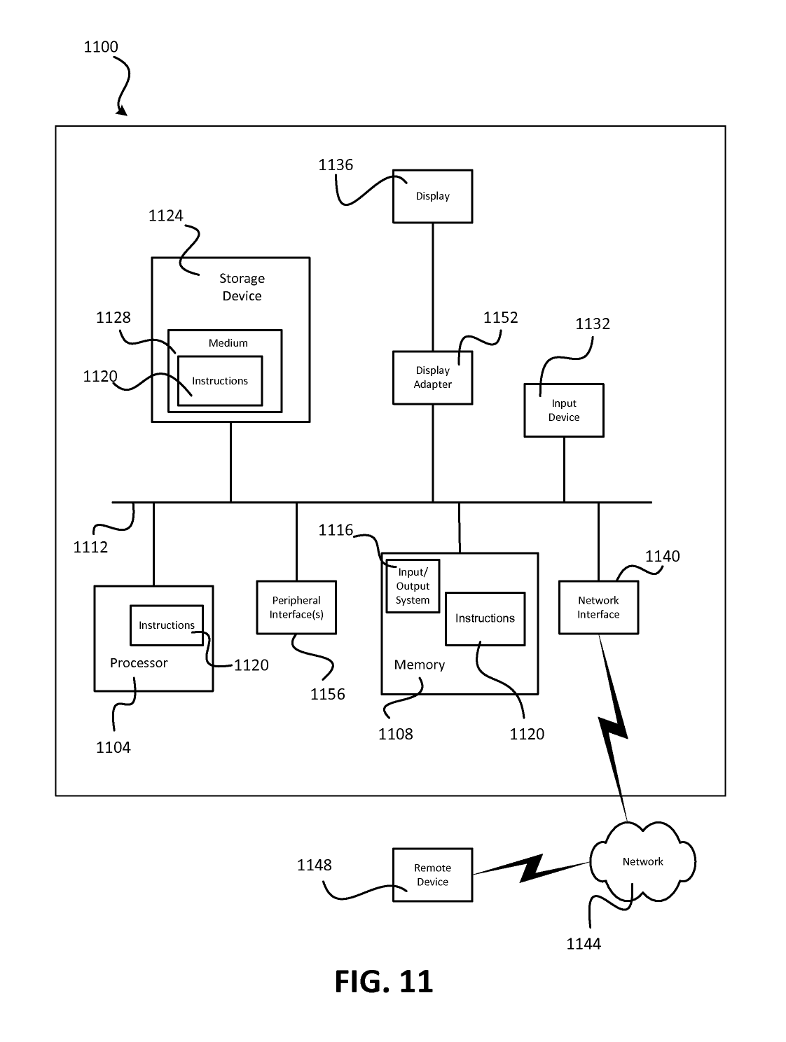

FIG. 11 shows a diagrammatic representation of one embodiment of a computing device in the exemplary form of a computer system 1100 within which a set of instructions for causing a control system, such as the measurement instrumentation 50 of FIG. 10 and/or other control systems, to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 1100 includes a processor 1104 and a memory 1108 that communicate with each other, and with other components, via a bus 1112. Bus 1112 may include any of several types of bus structures including, but not limited to, a memory bus, a memory controller, a peripheral bus, a local bus, and any combinations thereof, using any of a variety of bus architectures.

Memory 1108 may include various components (e.g., machine-readable media) including, but not limited to, a random access memory component, a read only component, and any combinations thereof. In one example, a basic input/output system 1116 (BIOS), including basic routines that help to transfer information between elements within computer system 1100, such as during start-up, may be stored in memory 1108. Memory 1108 may also include (e.g., stored on one or more machine-readable media) instructions (e.g., software) 1120 embodying any one or more of the aspects and/or methodologies of the present disclosure. In another example, memory 1108 may further include any number of program modules including, but not limited to, an operating system, one or more application programs, other program modules, program data, and any combinations thereof.

Computer system 1100 may also include a storage device 1124. Examples of a storage device (e.g., storage device 1124) include, but are not limited to, a hard disk drive, a magnetic disk drive, an optical disc drive in combination with an optical medium, a solid-state memory device, and any combinations thereof. Storage device 1124 may be connected to bus 1112 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 1124 (or one or more components thereof) may be removably interfaced with computer system 1100 (e.g., via an external port connector (not shown)). Particularly, storage device 1124 and an associated machine-readable medium 1128 may provide nonvolatile and/or volatile storage of machine-readable instructions, data structures, program modules, and/or other data for computer system 1100. In one example, software 1120 may reside, completely or partially, within machine-readable medium 1128. In another example, software 1120 may reside, completely or partially, within processor 1104.

Computer system 1100 may also include an input device 1132. In one example, a user of computer system 1100 may enter commands and/or other information into computer system 1100 via input device 1132. Examples of an input device 1132 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 1132 may be interfaced to bus 1112 via any of a variety of interfaces (not shown) including, but not limited to, a serial interface, a parallel interface, a game port, a USB interface, a FIREWIRE interface, a direct interface to bus 1112, and any combinations thereof. Input device 1132 may include a touch screen interface that may be a part of or separate from display 1136, discussed further below. Input device 1132 may be utilized as a user selection device for selecting one or more graphical representations in a graphical interface as described above.

A user may also input commands and/or other information to computer system 1100 via storage device 1124 (e.g., a removable disk drive, a flash drive, etc.) and/or network interface device 1140. A network interface device, such as network interface device 1140, may be utilized for connecting computer system 1100 to one or more of a variety of networks, such as network 1144, and one or more remote devices 1148 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 1144, may employ a wired and/or a wireless mode of communication. In general, any network topology may be used. Information (e.g., data, software 1120, etc.) may be communicated to and/or from computer system 1100 via network interface device 1140.

Computer system 1100 may further include a video display adapter 1152 for communicating a displayable image to a display device, such as display device 1136. Examples of a display device include, but are not limited to, a liquid crystal display (LCD), a cathode ray tube (CRT), a plasma display, a light emitting diode (LED) display, and any combinations thereof. Display adapter 1152 and display device 1136 may be utilized in combination with processor 1104 to provide graphical representations of aspects of the present disclosure. In addition to a display device, computer system 1100 may include one or more other peripheral output devices including, but not limited to, an audio speaker, a printer, and any combinations thereof. Such peripheral output devices may be connected to bus 1112 via a peripheral interface 1156. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

1. A method of determining one or more parameters associated with materials adjacent a cavity having at least one sidewall, the method being at least partially implemented with measurement instrumentation and comprising:
disposing at least a portion of a flexible, substantially impermeable liner within the cavity such that it is proximal to the at least one sidewall;
disposing one or more waveguides, comprising one or more electrical conductors, proximal to the liner such that the one or more waveguides are proximal to and substantially electrically insulated from the at least one sidewall; and
monitoring electrical characteristics of the one or more waveguides via the measurement instrumentation to determine one or more parameters associated with the materials at the at least one sidewall.

2. A method according to claim 1, wherein said monitoring electrical characteristics of the one or more waveguides includes ascertaining a spatial profile of electrical or dielectric properties of the materials.

3. A method according to claim 2, wherein said monitoring electrical characteristics of the one or more waveguides includes monitoring the electrical characteristics of the one or more waveguides using time domain reflectometry.

4. A method of installing a system usable for determining one or more parameters associated with materials adjacent a cavity having at least one sidewall, the method comprising:
disposing at least a portion of a flexible, continuously impermeable liner within the cavity such that it is proximal to the at least one sidewall; and
disposing one or more waveguides, comprising one or more electrical conductors, proximal to the liner such that the one or more waveguides are proximal to and substantially electrically insulated from materials adjacent the cavity.

5. A method according to claim 4, further comprising filling the liner with a fill material.

6. A method according to claim 5, wherein the fill material has a low dielectric constant.

7. A method according to claim 4, wherein the liner comprises polyurethane-coated nylon.

8. A method according to claim 4, wherein said disposing the one or more waveguides proximal the liner includes attaching the one or more waveguides to the liner with an adhesive material.

9. (canceled)

10. A method according to claim 4, wherein said disposing the one or more waveguides proximal the liner includes embedding the electrical conductors in the liner.

11. A method according to claim 4, further comprising using a borehole casing to prevent the borehole from collapsing.

12. A method according to claim 11, further comprising withdrawing the borehole casing and filling the liner either concurrently or in alternating increments.

13. A system for determining one or more parameters associated with materials adjacent a cavity having at least one sidewall and proximate and distal portions, the system comprising:
a flexible, substantially impermeable liner designed and configured to be disposed at least partially within the cavity such that it is proximal to the at least one sidewall; and
one or more waveguides, comprising one or more electrical conductors, designed and configured to be deployed in conjunction with said liner such that said one or more waveguides are proximal to said liner and proximal to and substantially electrically insulated from the at least one sidewall.

14. A system according to claim 13, wherein said one or more waveguides are disposed proximal to said liner in a non-overlapping fashion such that at most only one of said one or more waveguides is proximal to said liner at any given depth of the cavity.

15. A system according to claim 13, wherein said one or more waveguides are disposed proximal to said liner in an overlapping fashion such that two or more of said one or more waveguides are proximal to said liner at a particular depth of the cavity.

16. A system according to claim 13, wherein said one or more waveguides include at least two waveguides of differing lengths.

17. A system according to claim 13, wherein said one or more waveguides include at least two waveguides and said liner is designed and configured to dispose said at least two waveguides at different depth intervals.

18. A system according to claim 13, wherein at least one of the one or more waveguides extends from the proximate portion of the cavity to the distal portion of the cavity when said liner and said at least one of the one or more waveguides are deployed in the cavity.

19. A system according to claim 18, wherein, when said liner and said at least one of the one or more waveguides are deployed in the cavity, the distal portion of the cavity is located deeper inside the material than the proximate portion.

20. (canceled)

21. A method according to claim 4, wherein said disposing the one or more waveguides proximal the liner includes disposing the waveguide in a pocket of the liner.

22. A system according to claim 13, wherein said one or more waveguides are disposed inside said liner and said liner includes an opening allowing for connection of said one or more waveguides to a measurement instrument.
